(19) United States
(12) Patent Application Publication
(10) Pub. No.: US 2025/0072308 A1
(43) Pub. Date: Mar. 6, 2025

(54) THREE-PROPELLER INTER-FURROW WEEDER ASSEMBLY

(71) Applicant: German Alejandro Darico, Cordoba (AR)

(72) Inventor: German Alejandro Darico, Cordoba (AR)

(21) Appl. No.: 18/817,294

(22) Filed: Aug. 28, 2024

(30) Foreign Application Priority Data
Aug. 30, 2023 (AR) P20230102301

(51) Int. Cl. A01B 39/19

(52) U.S. Cl. CPC A01B 39/19

(57) ABSTRACT

An assembly for weed cutting in the inter-furrow of both extensive and intensive crops, including a main body that operates in a horizontal plane with three mounted propellers. One propeller remains fixed at its central location, while the other two have radial movement that can be manually or computer-controlled and can be positioned in front of or behind the fixed propeller. All three propellers are driven by a motor, independent of the forward movement of the machine or agricultural implement to which it is attached via the front tool bar through components forming a parallelogram. This setup facilitates weed cutting in the inter-furrow of crops and ensures soil surface protection by incorporating two linearly arranged leveling wheels.

### FIELD OF THE INVENTION

The main objective of the present invention is to have, in the same line and perpendicular to the forward direction, one or more bodies that work on a horizontal plane parallel to the ground. Each main body is composed of three propellers with autonomous rotation, synchronized and independent of the movement of the tractor or agricultural machine. These propellers are spatially arranged in the same horizontal plane, forming an isosceles triangle, where at each vertex of the base is located a propeller with radial mobility relative to the centroid of the triangular shape. The movement of these propellers is manually controlled by software that analyses the sequences of images captured during the advance of the tractor or driving machine, while the third propeller remains fixed at the opposite vertex. The main body that operates on a horizontal plane has mechanical proximity control to the ground and is operatively connected at one end to a parallelogram-shaped support, where the opposite end of the support is linked to a tool carrier bar incorporated at the front of a tractor or driving machine. It is distinguished by a novel construction modification, through which its performance clearly surpasses existing methods in the process of eliminating weeds or unwanted plants lodged between the rows of extensive crops such as maize, soybeans, and sunflowers.

Additionally, and added to the possibility to position the movable propellers radially both in front of and behind the fixed-position propeller, it can be used with the same effectiveness in vegetable crops.

### BACKGROUND OF THE INVENTION

In sustainable production systems, soil fertility is of great importance. The soil and its biological activities are key components and must be optimized in relation to seed germination and the growing conditions of the intended crop (Lampkin 1994). When discussing tillage objectives, soil management has traditionally had weed control as a secondary aim.

However, in most cases, mechanical weed control operations using soil-working tools also enhance soil aeration and water infiltration, including related positive effects. Mechanical weed control has received increased attention in recent years. The main reason has been the intention to reduce or completely replace the use of herbicides, as required in organic production systems, since consumers demand high-quality and safe food products and place particular emphasis on environmental protection.

Mechanical cultivation of row crops has a long tradition. One of the reasons for the invention of the seed drill was to enable the weeding of cereal seedlings between rows.

At that time, this operation was new compared to the common method of broadcast sowing between rows. Nowadays, inter-furrow weeding is frequently used, and the effectiveness of weed control is highly valued and widely accepted. When using the standard hoe, the remaining challenge is to control weeds within the row (intra-furrow weeding).

The aim of this chapter is to highlight and focus on the novel and promising developments in intra-furrow weeding those deals with the soil. Thanks to these technological advancements, such as precise inter and intra-furrow weeders, it is now possible to control weeds in a manner that meets both consumer and environmental demands.

### STATE OF THE ART

The harrow and the hoe are the oldest, most mature, and most common non-chemical weeding operations, treating both the entire surface and the inter-furrow area. The harrow is mainly used as a treatment for the entire soil surface, for example, in cereal crops.

Rasmussen (1992): The choice of machinery, timing, and adjustment are of great importance for achieving the best results in terms of selectivity to reduce weed density and minimize crop losses.

Van der Weide (2008): In row crops, the harrow is now also used alongside the hoe to tackle weeds in the inter-furrow area. Its effectiveness largely depends on the selectivity effects, as in most cases the crop plant is treated in the same way as the neighboring weeds.

In general, the effectiveness of weed control is often unsatisfactory.

Although the hoe is a very ancient tool, it is still used today as a standard instrument for weed control, alleviating the crop's competition for soil resources.

Laber (1999) defined and classified the hoe into three principles of control:

Operational principle: Treatment of soil between crop rows.

Physical principle: Cutting the roots/stems of weeds.

Physiological principle: Reduction of photosynthesis and water transpiration.

Vanhala (2004) states that, as in most mechanical treatment operations, losses of crop plants always occur, especially when aiming for high efficiency in weed control. These losses can result from soil coverage, damage to the crop leaves, damage to the roots, and disturbances.

There exists a conflict of objectives between maximizing the treated area to increase the efficacy of weeding and minimizing crop losses while maintaining sufficient distance from the crop rows. Therefore, adjusting the working width of the hoe unit becomes an important factor in achieving an acceptable crop outcome. This outcome is a compromise between the maximum cultivated area and suitable tolerance when adjusting the machine to avoid damage to the crop.

This divergence has led to various developments and research aimed at automating the lateral control of conventional hoes, based on the use of geographical coordinates (GPS) and computer visualization, which are the most promising principles of automation.

The hoe is used for weed control in row crops, primarily in the production of sugar beet, maize, and vegetables, treating the soil surface between the crop rows.

Row hoeing machines based on soil-engaging tools controlled by computer to manage the inter-furrow area and avoid crop damage must include information about the location of the crop plants in their control systems, as they use non-selective tools.

Home (2003) developed a combination of inter-row and in-row hoeing. It consists of a “duck-foot” blade between the rows, with reciprocal blades attached for treating weeds within the rows (FIG. 11.1). Plants are detected using computer vision that can distinguish between crop plants and weeds. When a plant is detected, the blades fold inwards, and when no plants are present, the motor activates the cam and the blades extend outwards.

Autonomous vehicles with inter-furrow and in-crop mechanisms lost accuracy as the speed increased, leading to the incorporation of new control mechanisms as well as monitored images, which have considerably reduced the undesired effects.

The French company Radis Mechanization has developed a weed control system within the row, consisting of blades mounted on a pivoting arm. Light sensors detect crop plants within the row, and the mechanism was designed for very spaced-out vegetables. The minimum distance between rows that the system can work with is 220 mm.

The rotary disc hoe consists of a rotating disc that acts in a horizontal plane and has a sector and a bevel cut into its circumference.

The center of the disc moves a parallel distance to the crop row, so that its sweeping area passes between the plants and also between the rows. The beveled cutting sector allows the disc to pass between the plants without making contact with them, and it also leaves a circular area of soil undisturbed around them. The disc disturbs the soil between the direct sowing areas among the plants, thus providing weeding within the row.

Garford Farm Machinery built a prototype of a rotary disc hoe based on a standard row-guided hoe controlled by vision. Field research on transplanted cabbages planted with a row spacing of 300 mm has shown that it is a very effective mechanism, destroying approximately 60% of weeds within an 80 mm radius of the crop. At larger radii, this increases to up to 80% of the weed population.

Osnabrück University of Applied Sciences, in collaboration with Amazone Werke (both from Germany), has developed a mechanical weed control system for in-row crops, primarily maize, based on georeferenced seed data derived from the crop planting operation as input data for real-time control.

In summary, the crucial importance of proper functioning of weeding tools will become evident later when the development and performance of the crop are assessed, as weeds interfere with the consumption of soil resources, sunlight, water, fertilizers, etc.

In view of the current state of the art regarding inter-furrow weeding tools with a fixed rotating propeller at a single point, it would be highly advantageous to have a set of three propellers with synchronized autonomous rotation, where two of the propellers have radial mobility to achieve precise and close cutting to the crop, regardless of inter-furrow spacing accuracy, the linear continuity of the furrow, the speed of the tractor or driving machine, and to do so under all circumstances with maximum regularity, control, and minimal soil degradation, surpassing existing products on the market.

### SUMMARY OF THE INVENTION

Therefore, it is an object of the present invention to provide a new main body that operates in a horizontal plane composed of a set of three propellers with synchronized autonomous rotation, where only two of them have radial mobility, for inter-furrow weeding of weeds that allows for improved, uniform, and precise action, regardless of the speed of the tractor or driving machine, as well as the inter-furrow spacing and/or straightness of the furrows, without affecting the crop or the furrow area where it is located.

It is also another object of the present invention to provide a new main body that operates in a horizontal plane composed of a set of three propellers with synchronized autonomous rotation, where only two of them have radial mobility, suitable for use in any type of soil and constant inter-furrow spacing, as minimal distortion is detected, processed, and channeled to the corresponding propeller or propellers for correction.

It is also another object of the present invention to provide a new main body that operates in a horizontal plane composed of a set of three propellers with synchronized autonomous rotation, where only two of them have radial mobility, with the minimum distance of approach to the soil surface being mechanically defined and controlled throughout the operation.

It is also another object of the present invention to provide a new main body that operates in a horizontal plane composed of a set of three propellers with synchronized autonomous rotation, where only two of them have radial mobility. In this embodiment, terrain irregularities are copied by a vertically adjustable reference wheel mounted on a body fixed to a parallelogram body and transferred to the front segment of the main body operating in a horizontal plane, maintaining a constant minimum distance to the soil surface throughout the operation. Additionally, a second reference wheel, positioned linearly and oppositely to the vertically adjustable reference wheel mounted on a body fixed to the parallelogram body, is in operational communication with the rear segment of the main body operating in a horizontal plane, also maintaining a constant minimum distance to the soil surface throughout the operation.

It is also another object of the present invention to provide a new main body that operates in a horizontal plane composed of a set of three helices with synchronized autonomous rotation, where the main body operating in a horizontal plane is positioned in operational continuity with one end of a parallelogram body, achieving controlled vertical movement of the main body operating in a horizontal plane.

It is another object of the present invention to provide a new main body that operates in a horizontal plane composed of a set of three propellers with synchronized autonomous rotation, where only two of them have radial mobility, and where the rotational speed of the propellers can be controlled manually or electronically.

It is still another object of the present invention to provide a new main body that operates in a horizontal plane composed of a set of three propellers with synchronized autonomous rotation, where the said movement will be provided mechanically, electrically, or hydraulically.

### BRIEF DESCRIPTION OF THE FIGURES

To illustrate the advantages briefly mentioned, which users and specialists in the field may add many more, and to facilitate the understanding of the construction, structural, and functional characteristics of the installation of a new main body that operates in a horizontal plane composed of a set of three propellers with synchronized autonomous rotation where only two of them have radial mobility, the following describes a preferred embodiment which is schematically illustrated without a specific scale in the attached drawings. It is expressly clarified that, precisely because this is an example, it should not be assigned a limiting or exclusive character regarding the scope of protection of the present invention but merely serves as an explanatory and illustrative intention of the basic concept on which the invention is based and represented in one of the preferred embodiments, purely by way of example, where:

FIG. 1 shows a plan view of a preferred embodiment of the new main body that operates in a horizontal plane composed of a set of three propellers with synchronized autonomous rotation, where only two of them have radial mobility, according to the present invention.

FIG. 2 shows a plan view with identification of the redirection cut of the new main body that operates in a horizontal plane composed of a set of three propellers with synchronized autonomous rotation, where only two of them have radial mobility, according to the present invention.

FIG. 3 shows a front view of the new main body that operates in a horizontal plane composed of a set of three propellers with synchronized autonomous rotation, where only two of them have radial mobility, according to the present invention.

FIG. 4 shows a side view of the new main body that operates in a horizontal plane composed of a set of three propellers with synchronized autonomous rotation, where only two of them have radial mobility, with its linear arrangement following the parallelogram body that connects with the tool bar of the tractor or agricultural machine that transports it, according to the present invention.

FIG. 5 shows a front view of the new main body that operates in a horizontal plane composed of a set of three propellers with synchronized autonomous rotation, where only two of them have radial mobility, according to the present invention.

FIG. 6 shows a side view of the new main body that operates in a horizontal plane composed of a set of three propellers with synchronized autonomous rotation, where only two of them have radial mobility, with its linear arrangement inside the parallelogram body that connects with the tool bar of the tractor or agricultural machine that transports it, according to the present invention.

FIG. 7 shows the flow diagram developed by the actions of the electronic control governing the radial movements of the two propellers with radial mobility.

It is on record that the schematic inclusion of a parallelogram module and the tool bar is solely for the purpose of illustrating the location of the new main body that operates in a horizontal plane composed of a set of three propellers with synchronized autonomous rotation, where only two of them have radial mobility, according to the present invention. This module can have various configurations, materials, and/or arrangements, while maintaining the characteristics and functionalities of the new main body with three synchronized autonomous rotating propellers, where only two have radial mobility, according to the present invention.

### DETAILED DESCRIPTION OF THE INVENTION

### Description of the Device

It is clarified that both the parallelogram module, the tool bar, the rotational drives, whether mechanical bodies, electric motors, or hydraulic motors, the morphology of the propellers, and the bracket for the reference wheel are well-known in the field of art and, for this reason, have not been illustrated or described in detail. The object of the present invention focuses on a main body that operates in a horizontal plane composed of a set of three propellers with synchronized autonomous rotation, where only two of them have radial mobility, and it can be adapted without any issues to any type of tractor, driving machine, or self-propelled agricultural implement.

Referring now to the Figures, it can be seen that the present invention consists of a main body that operates in a horizontal plane composed of a set of three propellers, with synchronized autonomous rotation independent of the advance of the tractor, driving machine, or self-propelled agricultural implement to which it is incorporated. It allows for variation in rotational speed manually or electronically while the tractor or machine is either working or stationary. This feature ensures constant control and uniformity of the weed cutting process and its distance from the soil, providing stable performance at minimal distance from the ground without requiring external forces, solely through the use of reference wheels that affect the verticality of the main body, making the soil variations more practical, efficient, and uniform in the weeding process.

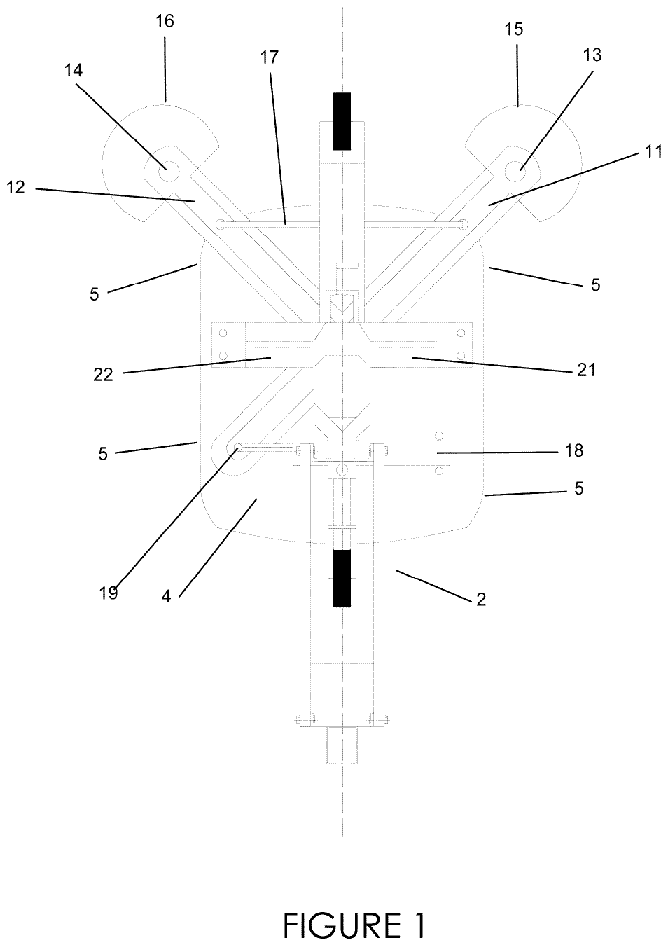

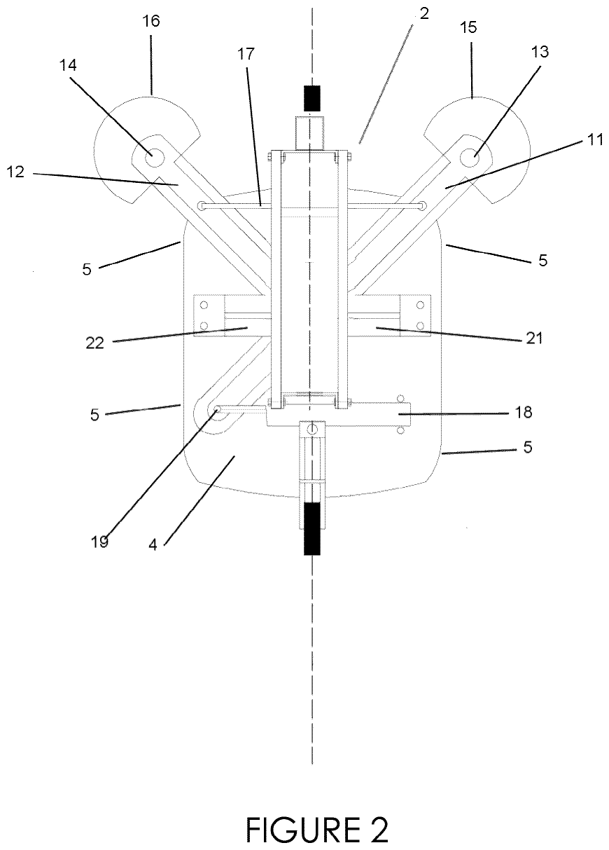

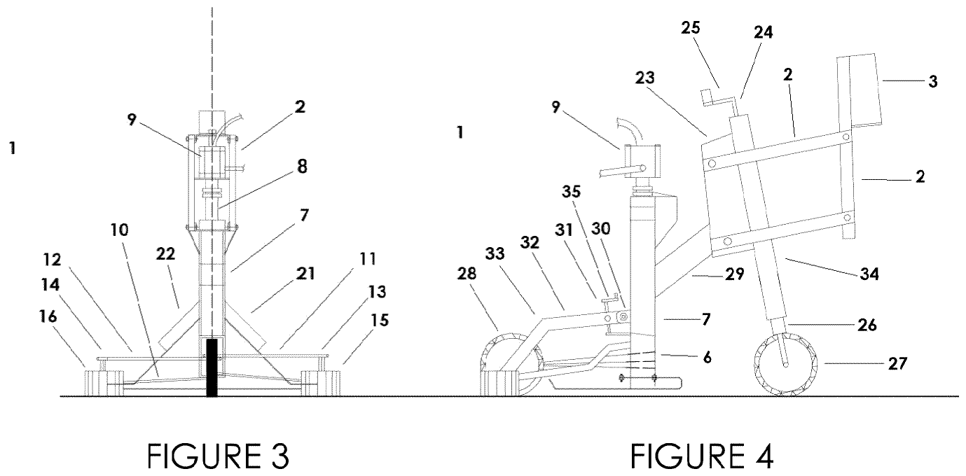

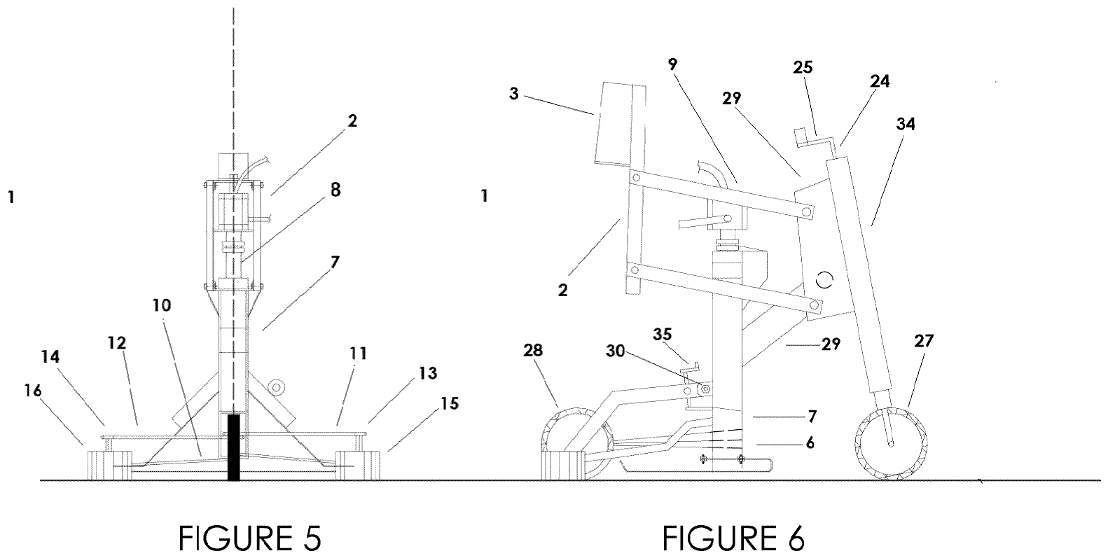

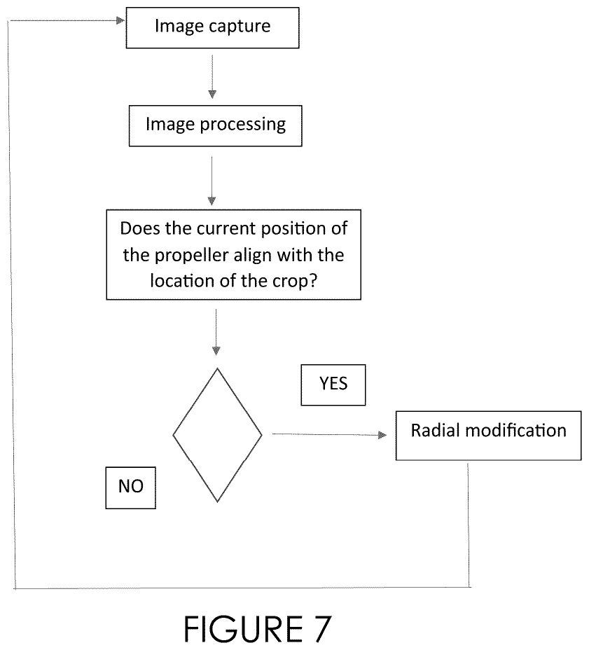

As shown in FIGS. 1 to 5, the present invention is indicated by reference (1) and is mounted or attached to one end of the parallelogram body (2), positioned in front and operationally aligned with the tool bar (3), which is not fully illustrated. The main body (4) operates in a horizontal plane and is rectangular in shape with rounded corners (5). A circular through-hole (6) is defined at its centroid, which incorporates an internal tubular cylindrical body (7) housing a cylindrical shaft (8) with threaded ends extending beyond the tubular cylindrical body (7) in both directions. The upper end connects operatively with a motor (9), while the lower end connects with one of the three propellers (10). Above the upper surface of the main body (4) operating in a horizontal plane, it is kinematically connected to two preferably rectangular bodies (11 and 12), at their free ends (13 and 14), which operatively connect each of the remaining two propellers (15 and 16). Both propellers (15 and 16) acquire rotational movement through the gimbal body linked to the respective rectangular bodies (11 and 12), and both propellers (15 and 16) acquire radial movement via a threaded rod (17) that, operatively connected to the rectangular bodies (11 and 12), allows manual adjustment and establishment of the spacing between the propellers (15 and 16). An electromechanical/electrohydraulic piston body (18) is rigidly connected to the main body (4) and operationally to body (11) at the intersection point (19), through which the approach and/or departure from the inter-row margins is adjusted manually or automatically via a computerized system (20). This system takes, reads, and analyses real-time images of the working environment, allowing for the identification of the crop's distance and position in its furrow and, with this information, radially adjusts the helices to carry out weeding as close as possible to the crop without causing damage. Parallel to the base of the main body (4) and extending diagonally from each side of the main body (4) towards its centroid, a preferably rectangular body (21 and 22) is developed to fit the tubular cylindrical body (7). Above this and perpendicular to the rectangular bodies (21 and 22), it connects operatively with a double parallelogram body (2), whose free ends are operatively linked to a preferably rectangular hollow body (23). The inner face of this body is rigidly connected to a preferably circular body (34), which houses and secures a threaded body that contains a threaded shaft (24). The upper end of this shaft forms a crank body (25), while the opposite end connects to a fork body (26) with enough internal space to integrate a wheel (27), which maintains a constant distance between the ground surface and the main body (4), copying the soil variations in a more practical, efficient, and uniform manner in the weeding process.

Furthermore, the present invention features a main body (4) that operates in a horizontal plane, incorporating a set of three propellers (10, 15, and 16) with synchronized autonomous rotation in the same direction. One of them (10) is statically and spatially positioned at the center of the main body (4), while the other two propellers (15 and 16), arranged laterally to the central one so that their perimeters do not overlap, have radial mobility in the opposite direction to the center of rotation of the propeller (10).

Additionally, the present invention is equipped with a rotation device (9) spatially defined at the upper end of the support arm between the parallelogram body (2) and the main body (4). This device uses rigid and/or flexible gimbal elements, and/or gears and chains to provide synchronized rotational movement in the same direction to the three propellers (10, 15, and 16), with the ability to vary or stop the speed according to the needs of the operation.

The present invention ensures the integrity of the soil surface by maintaining a constant distance between the three propellers (10, 15, and 16) and the soil surface using two wheels (27 and 28) arranged along the longitudinal axis passing through the centroid of the main body (4) operating in a horizontal plane. Both wheels (27 and 28) have manually controlled vertical movement, with wheel (28) located opposite the parallelogram body (2) controlled by a threaded shaft (31) linked to the predominantly circular body (7), and wheel (27) controlled by a threaded shaft (24) that integrates operatively with a predominantly circular body (34) through an internal threaded body. These wheels (27 and 28) not only set the minimum height of separation between the three propellers (10, 15, and 16) and the soil surface but also fix this height to be maintained constant during operation.

Additionally, the three propellers (10, 15, and 16) are spatially and operationally aligned with the longitudinal axis of the tractor or self-propelled machine's direction of travel to ensure that, after passing, the soil area is left free of weeds, allowing for better crop development without competing for soil resources and without causing damage to the soil surface or crops aligned in the furrows.

In this manner, the set of three propellers (10, 15, and 16) with synchronized autonomous rotation, provided by a motor (9), includes one fixed propeller (10) that performs its function in the space between the two movable propellers (15 and 16). These latter propellers are controlled and directed in their radial movements for approaching and/or distancing from the crop through a real-time visualization and analysis system. This system allows the propellers to weed as close as possible to the crop stalks without damaging the plants or the soil surface, as the surface irregularities of the terrain are mechanically copied and transferred to the main body (4) operating in a horizontal plane.

In the state of the art, various forms, methodologies, and internal or external additions to non-chemical weeding systems have been proposed over time, mainly to avoid soil contamination that could be absorbed by crops, given the scientifically and medically proven damage such products cause to fauna and humans.

Thus, the non-chemical weed removal of inter-furrows in extensive crops of the present invention ensures both the unaltered state of the treated soil area and the crop itself. This is achieved through the synchronized autonomous rotation process of the propellers, independent of the tractor or self-propelled machine's speed, and the radial movement of the two lateral propellers that ensure weed cutting across the entire inter-furrow area. This independence from the perfect linear conformation of the inter-furrow is facilitated by the radial movements controlled, processed, and executed via a computer program that analyses real-time photographic capture of the inter-furrow.

### Operation of the Invention Device

As an example, but not limiting to the invention, and to ensure proper operation of the three-propeller weeder with physical and/or electronic control of the approach to the furrow, applicable in extensive crops and, depending on work characteristics, also in intensive crops, the following points should be verified and controlled:

Ensure that the parallelogram body (2) is firmly fixed to the tool bar (3) to support the assembly.

Verify that the kinematic assembly providing rotation (9) is connected and regulated according to the task to be performed.

Confirm that the minimum distance between the three propellers (10, 15, and 16) and the soil surface is appropriate and adjusted (25 and 35).

Ensure that the real-time control computer systems are operational with the parameters set for proper operation.

After a few meters, check each inter-furrow processed to confirm that weeds have been eliminated without affecting the crops or their furrows.

Start the full operation circuit, observing the condition of the processed inter-furrows, and the undisturbed state of the furrows and crops following the weeding operation of the three-propeller weeder with physical and electronic control of the approach to the furrow, applicable in extensive crops and, depending on work characteristics, also applicable in intensive crops.

Having described and determined the nature of the present invention and how it is to be carried out, the following is claimed as proprietary and exclusive rights:

1. A three-propeller inter-furrow weeder assembly comprising:
a main body (4) that operates in a horizontal plane;
three propellers (10, 15, and 16) are mounted and obtain rotation in one direction from a motor (9), independent of a forward movement of an agricultural machine or implement to which the three-propeller inter-furrow weeder is attached via the front tool bar (3) through components forming a parallelogram body (2), facilitating its operation in the inter-furrow of crops to cut weeds:
the main body (4) defines a flat rectangular shape with rounded corners, and includes a central through-hole housing a hollow cylindrical body (7) containing a cylindrical shaft (8) with threads at both ends extending beyond the limits of the hollow cylindrical body (7), incorporating at the lower end one of the three propellers (10) fixed spatially and at the opposite end a motor;
wherein the hollow cylindrical body (7) is linearly connected to a first trapezoidal body (29) which is solidarity linked to a second trapezoidal body (23) to which parallel arms of a parallelogram body (2) are freely attached;
wherein the perpendicular opposite arms are fixed to a rectangular longitudinal body (3) belonging to the agricultural machine;
wherein inside the parallelogram body (2) linked to the trapezoidal body (23) is a hollow cylindrical body (34) housing an internal threaded body through which a threaded shaft moves;
wherein an upper end of the threaded shaft forms a crank handle (25) and at the opposite end is coupled to a fork body (26) with a wheel (27);
wherein below the line where the hollow cylindrical body (7) and the trapezoidal body (29) are fixed, a vertical quadrangular body with a central through-hole serves as a pivot for a rectangular body (32) with a fork-shaped end (33) housing a wheel (28);
wherein near the pivot point and on the rectangular body (32) is a horizontally developed rectangular body with a central threaded hole through which a threaded shaft (31) moves, connecting operatively at a lower end to a fixed support while an upper end forms a crank handle (35);
wherein two rectangular bodies (5) with cylindrical through-holes (13 and 14) are incorporated above the hollow cylindrical body (7) on the upper part of the main body (4);
wherein the two propellers (15 and 16) are correspondingly arranged in the lower section, while at the top they communicate with a threaded body (17), and an electromechanical/electro-hydraulic piston (18) is solidarity linked to the main body (4) and operatively to the body (11).

2. The three-propeller inter-furrow weeder assembly according to claim 1, wherein the central through-hole of the main body (4) houses a hollow cylindrical body (7) through which a threaded shaft moves, with ends extending beyond the length of the hollow cylindrical body (7), incorporating at the lower end one of the three propellers (10) fixed in spatial position and at the opposite end an electric/hydraulic motor providing rotational movement to a kinematic assembly.

3. The three-propeller inter-furrow weeder assembly according to claim 1, wherein within the parallelogram body (2) on the trapezoidal body (23), a hollow cylindrical body (34) is developed, which houses an internal threaded body through which a threaded shaft (24) moves, with the upper end forming a crank handle (25) and the opposite end fixed to a fork body (26) with a wheel (27).

4. The three-propeller inter-furrow weeder assembly according to claim 1, wherein opposite the parallelogram body (2) from the hollow cylindrical body (7), below the line where the trapezoidal body (29) is fixed, a vertical quadrangular body with a central through-hole serves as a pivot for a rectangular body (32) with a fork-shaped end (33) housing a wheel (28).

5. The three-propeller inter-furrow weeder assembly according to claim 1, wherein a horizontally developed rectangular body with a central threaded hole is positioned on the rectangular body (32) near the pivot point, where a threaded shaft (31) moves, wherein at the lower end, connects operatively to a fixed support solidarity attached to the hollow cylindrical body (7), and at the upper end, forms a crank handle (35).

6. The three-propeller inter-furrow weeder assembly according to claim 1, wherein on the hollow cylindrical body (7) slightly above the main body (4), two predominantly rectangular bodies (5) with cylindrical through-holes (13 and 14) are freely incorporated, wherein the two propellers (15 and 16) are arranged in the lower section, while at the top they communicate with a threaded body (17).

7. The three-propeller inter-furrow weeder assembly according to claim 1, wherein an electromechanical/electro-hydraulic piston (18) is solidarity linked to the main body (4) operating in a horizontal plane and to the body (11).

8. The three-propeller inter-furrow weeder assembly according to claim 1, wherein parallel and close to each side of the main body (4), and towards the central through-hole, two rectangular bodies (21 and 22) are diagonally developed, adjusting to the hollow cylindrical tubular body (7).

9. The three-propeller inter-furrow weeder assembly according to claim 1, wherein the three propellers (10, 15, and 16) acquire circular movement in the same rotational direction from a single kinematic train initiated by a motor and transferred through a rigid/flexible cardan joint or a gear and pinion or gear and chain system.

10. The three-propeller inter-furrow weeder assembly according to claim 1, wherein a central and fixed propeller (10) is located at the central through-hole of the main body (4).

11. The three-propeller inter-furrow weeder assembly according to claim 1, wherein the lateral and radially movable propellers (15 and 16) are arranged in front of or behind the central and fixed propeller (10) relative to the forward direction of the tractor or agricultural machine.

12. The three-propeller inter-furrow weeder assembly according to claim 1, wherein the three propellers (10, 15, and 16) have rotational movement independent of the forward movement of the agricultural machine, provided by an electric or hydraulic motor and transferred through a kinematic train.

13. The three-propeller inter-furrow weeder assembly according to claim 1, wherein the weeder assembly is arranged linearly and following the parallelogram body (2) which connects to the tool bar of the tractor or agricultural machine, or linearly within the parallelogram body (2), without altering its weeding capacity.

14. The three-propeller inter-furrow weeder assembly according to claim 1, wherein the electromechanical/electro-hydraulic piston are controlled by a computer system that, through image capture of the inter-furrow and crop in the furrow and determination of geographical coordinates of the crop bodies, modifies the relative position of the radial movement propellers (15 and 16), and starts or stops the rotational movement of the three propellers.

15. The three-propeller inter-furrow weeder assembly according to claim 1, wherein the weeder assembly is use in extensive and intensive crops.
